(19) United States
(12) Patent Application Publication
(10) Pub. No.: US 2023/0051740 A1
(43) Pub. Date: Feb. 16, 2023

(54) MIXED-SPRAY FIREFIGHTING DEVICE

(71) Applicant: SHANDONG HAOXING JIESHI NEW MATERIAL TECHNOLOGY CO., LTD., Shandong (CN)

(72) Inventors: Zhiliang YANG, Shandong (CN); Yang YANG, Shandong (CN); Hao YANG, Shandong (CN); Tingyu MA, Shandong (CN); Meiqin YAO, Shandong (CN); Jinshui YAO, Shandong (CN)

(73) Assignee: SHANDONG HAOXING JIESHI NEW MATERIAL TECHNOLOGY CO., LTD., Shandong (CN)

(21) Appl. No.: 17/793,659

(22) PCT Filed: Jan. 17, 2021
(86) PCT No.: PCT/CN2021/072358

§ 371 Date: Jul. 19, 2022

(30) Foreign Application Priority Data
Jan. 19, 2020 (CN) 202010062276.8

(51) Int. Cl. B05B 7/14; A62C 99/00

(52) U.S. Cl. CPC B05B 7/1495; A62C 99/0045; A62C 99/0072; A62C 31/07

(57) ABSTRACT

The application discloses a mixed-spray firefighting device, which includes a water nozzle and a powder nozzle. The water nozzle is disposed around an outside of the powder nozzle, and a powder spray port of the powder nozzle is provided behind a water spray port of the water nozzle. A fire-extinguishing agent powder sprayed from the powder nozzle and a water flow sprayed from the water nozzle are mixed in air outside the firefighting device. The fire-extinguishing agent powder is preferably sodium polyacrylate resin powder. The application solves the technical bottleneck of using the sodium polyacrylate resin powder as a fire-extinguishing agent in the prior art, so that the sodium polyacrylate resin powder can be sprayed into a fire field smoothly and continuously without blocking the powder spray port.

### BACKGROUND

### Technical Field

The application relates to the technical field of firefighting equipment, in particular to a mixed firefighting device for spraying powder fire-extinguishing agent and liquid, and a mixed-spray method for powder fire-extinguishing agent and water.

### Description of Related Art

At present, water is still the most commonly fire-extinguishing agent, which has the advantages of low cost, easy availability, no pollution to the environment, etc. However, due to the good fluidity of water, most of the water will be lost after being sprayed into the fire, resulting in waste. Moreover, for big fires with large fire area, rapid development of fire behavior, easiness for re-ignition, and high difficulty in fighting, water fighting tends to only control the spread of fire, so it is difficult to put out the fire in a timely and effective manner. Dry powder fire-extinguishing agents widely used nowadays have poor effect on certain types of big fires, and the residues thereof cause serious environmental pollution though the fire-extinguishing effect thereof has been improved.

Superabsorbent resin (Super Absorbent Resin, SAR) is a type of novel functional polymer material containing strong hydrophilic groups such as carboxyl group, amide group and the like, and having a water-swelling type with a certain degree of cross-linking and a three-dimensional network structure. SAR is insoluble in water and organic solvents, and has unique properties—strong water absorption and water retention. Compared with traditional absorbent materials such as sponge, cotton, cellulose and silica gel, SAR has a large water-absorption capacity, can quickly absorb liquid water that is dozens or even thousands of times to its own weight, and has a strong water retention, and is hard to lose water even when heated and under pressure. Meanwhile, SAR has some characteristics of polymer materials. Due to these characteristics, the research of SAR has an extremely rapid development, and has been widely used in many fields such as agriculture, forestry and horticulture, medical and health, food industry, petrochemical industry, building materials and so on.

Superabsorbent resin has developed rapidly with a great variety, and has many classification methods. It is mainly classified according to the source of raw materials, hydrophilization way, and the type of hydrophilic groups, cross-linking manner and the form of product. The most commonly classification method is a method according to the source of raw materials, including starch-based superabsorbent resin, cellulose-based superabsorbent resin, synthetic superabsorbent resin, protein-based superabsorbent resin, blending and composite superabsorbent resin, etc.

The reason why superabsorbent resin can absorb water which is hundreds or even thousands of times to its own mass is that it has two conditions: first, it has hydrophilic groups such as carboxyl, hydroxyl, amide group and sulfonic acid groups, which makes it possible to absorb water; second, it has a structure of three-dimensional network and is insoluble in water, making water absorption a reality. Superabsorbent resin is a three-dimensional network polymer having hydrophilic groups and slight cross-linking, which not only can absorb a lot of water and swell, but also can keep water from flowing out. It has the advantages of high water absorption ratio, fast water absorption rate and strong water retention performance.

The application of superabsorbent resin, especially the polymer hydrogel of polyacrylic acid superabsorbent resin in the field of fire extinguishing, has the following advantages.

1. For the superabsorbent resin, after a side group of a polymer electrolyte is mixed with water, corresponding anionic hydrophilic groups and cations (movable ions) are generated by ionization, where the backbone network skeleton bears negatively charged anions which cannot move, thereby resulting in a power of network expansion due to the repulsion between anions. Although cations have certain mobility, they exist in the network due to the attraction and binding of the opposite charges on the network skeleton, so that the concentration of cations inside the network is greater than that in the external water, and an osmotic pressure is generated by the ions located inside and outside the network. Furthermore, large amount of water can enter the three-dimensional network in a very short time because the polymer electrolyte itself has strong hydrophilic groups. Under high temperature conditions, the superabsorbent resin fixed with a large amount of free water has a considerable heat capacity, and a large amount of heat may be expended during water loss, forming an effective isolation of heat source, which is beneficial to the control of fire behavior.

2. An elastic gel is formed after absorbing water of the superabsorbent resin, and the particles of such elastic gel are closely connected with each other, leaving no space for air to enter, which can isolate the fire source from air in the hydrogel state, and can prevent the re-ignition of dark fire, and protect objects that have been covered by gel in the fire field, so as to achieve the effect of rapid fire extinguishing.

3. A gel is formed after superabsorbent resin absorbs water, having an excellent chemical stability, a thermal stability and compatibility, and a very high viscosity, and thus having a good adhesion ability. After sprayed on vertical surfaces, it can cover the surfaces of objects without falling, producing a sufficient adhesion thickness, which can effectively improve the effectiveness of fire prevention of unburned objects in the fire field.

4. The superabsorbent resin is polymer powder, which is safe in storage, transportation and the like. It has a stability of more than two years in storage (sealed and anti-water absorption) and is non-toxic. In a strong fire, after heated and underwent water loss, the resin is burned into carbon dioxide and water, which are non-toxic to humans and animals. After the fire is extinguished, the residual resin in the fire field will degrade naturally within a few months, thereby being non-toxic and pollution-free to humans and environment, and environment-friendly.

5. The superabsorbent resin powder has low density and stronger water absorbing capacity, and can absorb more than 300 times water to its own weight in a very short time, and generally, the content of the resin powder is accounted for 0.05-0.5% by weight of water in the whole absorbent gel. Generally it is accounted for about 0.1%. A small amount of superabsorbent resin powder is required to produce a large amount of fire-extinguishing gels, so fire-extinguishing and firefighting effect is excellent, and the superabsorbent resin powder may continuously absorb water to avoid secondary damage caused by excess water flowing everywhere, thereby having an effect of saving water.

6. The superabsorbent resin powder is weakly acidic, weakly alkaline or neutral, and is not corrosive to a firefighting device.

In the prior art, there is a technology of using acrylic polymer to prepare a gel for fire extinguishing. For example, Chinese patent CN107497088A discloses a hydrogel fire-extinguishing agent and implementation method thereof. The application method of hydrogel fire-extinguishing agent includes dissolving a hydrogel fire-extinguishing agent in water, stirring for no more than 1 min, and preparing a solution with a mass concentration of 3-5‰, which can be used for fire extinguishing. CN107789085A discloses a new type of polymer gel water-based fire-extinguishing agent, where in use, a new type of environment-friendly polymer gel water-based fire-extinguishing agent is added into 600-1000 times of water in mass, and after stirring for 3-5 min, a polymer gel can be formed for fire extinguishing. CN207101696U discloses a new type of environment-friendly fire fighting truck, in which firstly, a material is put into a polymer fire-extinguishing material storage tank, so that the fire-extinguishing material enters a fire monitor pipeline, and water comes out of a water tank and enters the fire monitor pipeline through a water inlet of a fire pump; and the polymer material is fully mixed with the water in a spiral pipeline under the action of a rotary mixing device, followed by being emitted from the fire water monitor. CN100444912C discloses an application of a super-absorbent resin absorbent gel fire-extinguishing agent, in which a synthetic resin sodium polyacrylate is mixed with 1000 times of water, to produce an absorbent gel in half an hour, which can be sprayed into fire with a water gun; the fine powder of sodium polyacrylate is mixed with 1000 times of water, followed by being sprayed together from a spray gun to fire sites, producing a gel within 15 s-60 s, which has an effect of fire extinguishing.

However, the usage modes of these superabsorbent resin fire-extinguishing agents have major drawbacks. After long-term tests by the inventor, it is found that superabsorbent resin powder swells rapidly after absorbing water, and with the increase of water absorption amount, its viscosity becomes bigger and bigger, until it is finally close to a solidified state; and the stirred resin is very viscous and is prone to solidify. It is difficult to find a suitable way to spray these gel-like water-absorbent resins which are close to the solidified state, to be precise, spray them out instead of throwing them out in clumps by manpower or machines. Further, a pipeline of a firefighting device will be seriously blocked during the expansion of the resin, resulting in non-continuous spraying, and even device damage due to poor water flow and closed pipelines. Therefore, the application occasions of the above fire extinguishing modes are greatly limited.

In addition, in a firefighting device of the prior art, a solution of independent input pipelines combined with overlapping output pipelines will be generally adopted for mixing powdery fire-extinguishing agent and water flow. For example, Chinese patent CN201591928U discloses a pipe-in-pipe type composite spray fire monitor, referring to FIG. 1, which adopts separate input of various fire-extinguishing agents, and different fire-extinguishing agents are transported through the inner and outer pipes respectively, so that mixed liquid and ultra-fine dry powder are not mixed with each other during transportation, but combined at a nozzle, thereby retaining their respective characteristics completely; coupled with the wall-attachment effect of DC-pressure water or foam mixture, ultra-fine dry powder with good hydrophobicity can be carried to a greater distance. Chinese patent CN207722267U discloses a fire gun capable of adjusting a mixed ratio of water and ultra-fine dry powder fire-extinguishing agent, in which referring to FIG. 2, the front end of a gun body 8 is provided with a spray nozzle, the rear end of the gun body 8 is provided with an independent powder feeding pipe and an independent water feeding pipe, the front portion of the powder feeding pipe is sleeved inside the front portion of the water feeding pipe, a water passage cavity is reserved between the front portion of the powder feeding pipe and the front portion of the water feeding pipe, and the front end of the powder feeding pipe and the front end of the water feeding pipe are each connected with the spray nozzle.

For example, Chinese patent CN105148435A discloses a multi-functional firefighting coaxial nozzle device, referring to FIG. 3, which includes an outer-axis pipeline inlet interface for conveying a fire-extinguishing medium of an outer pipeline, and an inner-axis pipeline inlet interface for conveying a fire-extinguishing medium of an inner pipeline, an outer-axis pipeline valve, an inner-axis pipeline valve, a coaxial outer pipeline, a coaxial inner pipeline, an outer pipeline nozzle, an inner pipeline nozzle, and an inner and outer pipeline connection. It is subtly combined by two sets of independent fire-extinguishing nozzle devices, which can simultaneously spray two kinds of fire extinguishing media with the same or different properties or with the same properties and different functions to a fire field. Another example is Chinese patent CN109806532A, which discloses a composite jet fire-extinguishing spray device, referring to FIG. 4, including a first connecting pipe for conveying foam or water-based fire-extinguishing agent with one end provided with a discharge opening; a second connecting pipe for conveying dry powder driven by nitrogen with one end provided with a second discharge opening, the second discharge opening being disposed concentrically with the first discharge opening; an outer spray pipe with one end connected to the first discharge opening;

and an inner spray pipe which is located on the inner side of the outer spray pipe and is coaxially disposed with the outer spray pipe, where, one end of the inner spray pipe is threaded into the first connecting pipe and is configured to convey dry powder driven by nitrogen; and a passage for conveying foam or water-based fire-extinguishing agent is provided between the outer wall of the inner nozzle and the inner wall of the first discharge opening.

The above fire water monitors or water guns are each designed for traditional powder fire-extinguishing agents, especially dry powder fire-extinguishing agents; and dry powder fire-extinguishing agents are generally insoluble in water and do not absorb water, and other commercially-available fire-extinguishing agents will not have volume expansion and viscosity increase caused by water absorption, so this type of fire water monitors has no problem during use of dry powder fire-extinguishing agents and all fire-extinguishing agent powders will be taken away from the fire monitor with the strong scouring of water flow. However, serious problems arise when superabsorbent resin is used as a fire-extinguishing agent. In fact, superabsorbent resin is neither soluble in water nor hydrophobic, but can quickly absorb water molecules into a polymer structure and fix the water molecules, forming a gel with strong adsorption capacity. Therefore, with simultaneous water spraying and powder spraying, not all of resin powders can be taken away by strong water flow, which leads to more and more absorbent resins sticking near a powder spray port. After running for a period of time, the powder spray port will be completely blocked, and this problem will become more serious as various performance indicators of the superabsorbent resin become better. In the test conducted by our company, peripheral water flow will flow into or sputter or drop near an inner powder spray port in various ways. Due to a high viscosity and very rapid solidification, the resin after water absorption will be gradually piled up at a nozzle site, forming a volcano-like resin pile, and gradually compress a powder spray passage, and finally completely close a powder spray port. In the worst case, the water flow may flow directly to the powder spray port, and the solidified resin will directly block a pipeline inside the powder spray port in a very short time.

In addition, when the fire-extinguishing agent is another type of powder (such as water-soluble powder), it will also take place for water to backflow into a powder spray nozzle, especially at the beginning of fire extinguishing and at the water shut-down stage after completion of fire extinguishing. Certainly, powder fire-extinguishing agents used in firefighting are generally substances with excellent solubility. Once they encounter water, they will be dissolved in a large amount, producing very serious consequences: firstly, it is easy to produce undesired toxic substances or chemicals that cause corrosion to a fire device, and secondly, the dissolution process may take place relatively violently, which is prone to produce undesired strong reactions or generate a lot of heat.

In view of this, there is a need for such a firefighting device in the market, which can realize rapid mixing of fire-extinguishing agent powder, especially superabsorbent resin powder with water flow, and can continuously and stably convey mixed gel solution to a designated position.

### SUMMARY

The technical problem to be solved by the present application is to provide a firefighting device that can realize rapid mixing of fire-extinguishing agent powder, especially superabsorbent resin powder, with water flow, and can continuously and stably convey mixed gel solution or fire-extinguishing solution to a designated position.

The technical solution of the present application is to provide a mixed-spray firefighting device, including a water nozzle 1 and a powder nozzle 2, and the water nozzle 1 is disposed around an outside of the powder nozzle 2, and a powder spray port 4 of the powder nozzle 2 is provided behind a water spray port 3 of the water nozzle 1.

A fire-extinguishing agent powder sprayed from the powder nozzle 2 and a water flow sprayed from the water nozzle 1 are mixed in air outside the firefighting device.

The fire-extinguishing agent powder is preferably superabsorbent resin powder, especially sodium polyacrylate resin powder.

The powder spray port 4 of the powder nozzle 2 and the water spray port 3 of the water nozzle 1 refer to a position where a powder and a liquid are sprayed out of a closed pipe and in contact with outside air, respectively.

A distance between the powder spray port 4 of the powder nozzle 2 and the water spray port 3 of the water nozzle 1 in an axial direction is greater than 3 cm.

The powder spray port 4 is provided with a detachable water blocking jacket 11.

A drainage space 12 is provided between a pipe wall of the powder nozzle 2 and a pipe wall of the water nozzle 1.

A front portion of the water nozzle 1 is provided with an outer sleeve 10.

The water nozzle 1 is connected with a water spray pipe 5, and may spray high-pressure water flow or water mist; and the powder nozzle 2 is connected with a powder spray pipe 6, the powder spray pipe 6 is connected with a powder storage tank 7, and the powder storage tank 7 is connected with a high-pressure gas source 8.

The present application further provides a mixed-spray method for powder fire-extinguishing agent and water. Superabsorbent resin fire-extinguishing agent powder sprayed from the powder spray port 4 of the powder nozzle 2 is sprayed from the powder nozzle 2 in the middle, and is mixed with a water flow sprayed from surrounding water spray port 3 in air outside the water nozzle 1. The fire-extinguishing agent powder is sodium polyacrylate resin powder. The fire-extinguishing agent powder is sprayed from a rear of a position of the water spray port 3.

Compared with a large amount of mixed-spray firefighting devices that exist in the prior art, the present application has the advantages as follows:

1. The prior art generally adopts a solution of a water spray pipe sleeved on a powder spray pipe, in this way, the powder may be better mixed with the water together, and the powder may be transported farther by using the power of the water flow. The premise of this design idea is that the fire-extinguishing agent will be washed away by the water, without producing a lot of gelatinous substances when it encounters the water. However, when the superabsorbent resin powder is used as a fire-extinguishing agent, such a structure will allow the water flow of an outer layer to have too many opportunities to enter the powder spray port of an inner layer, forming a gel with very high viscosity, thereby causing a blockage. However, this design method of external water and internal powder does have its own advantages. For example, powdery fire-extinguishing agent is generally lighter, the air flow environment of the fire field is complicated, and the powder needs be blown out by compressed air, forming a relatively larger distribution surface. When the powder is sprayed from the middle of the water column, all the powder will directly hit a “water wall”. In this way, there will be a very little powder leakage and adequate mixing. In order to give full play to the advantages of the design of external water and internal powder and minimize its shortcomings, our company creatively proposed a technical solution of changing a position of the powder nozzle from the same plane or substantially the same plane as the water nozzle to a position behind the water nozzle. Under this solution, a structure where a water spray position and a powder spray position are substantially separated by a certain distance is formed. Through experiment, it can be found that due to the strong spray of the water flow from a closed pipe, a large amount of water mist or water droplets will be formed with the pipe wall on the side of the water nozzle when the surrounding pressure is reduced. If these water molecules are sputtered to the powder spray port closely next thereto, causing the powder spray port to be blocked. However, with the design of the rear powder spray port, the water droplets splashed by the spraying of the water flow in a straight line or the water flow gathered together basically have no opportunities to enter the area near the powder spray port, which minimizes the possibility of the powder spray port getting wet. In fact, it is equivalent to hide the water spray port behind the water spray port. Experiments have proved that the firefighting device of this structure can operate continuously for tens of minutes without blockage.

2. A water barrier space is reserved between the water nozzle and the powder nozzle, so that the water flowing towards the powder spray port can directly flow into the water barrier space, and then be discharged from or temporarily stored in the water barrier space to avoid the water flowing directly towards the powder spray port, because it can be found from experiments that most of the water flowing towards the powder spray port flows along the inner wall. In addition, it can also be ensured that the water column is not sprayed against an outer wall of the powder spray pipe, which is equivalent to separating the water spray port and the powder spray port by a certain distance B in a radial direction, combined with the separated distance A in an axial direction, which can minimize the influence of the water spray splashed from the water spray port on the powder spray port. At the same time, due to the existence of the water barrier space, the diameter of the water spray port is actually increased, so that the converging point of sprayed hollow water column in the air is farther away from the powder spray port, which is beneficial for the resin powder to enter the water column.

3. Since the water flow is strongly sprayed around an annular pipe, the shape of the obtained water column is obviously different from the shape of the water column obtained by spraying from a common water pipe, roughly showing a hollow annular water column, and this water column will be converged at a position which has a certain distance from the water spray port. In this way, the resin powder is mixed with the water flow in the air at a certain distance from the spray port, instead of original mixing inside the spray port or at the outlet, which greatly reduces the opportunity of the water flow entering the area near the powder spray port, and maximizes the use of physical properties of superabsorbent resin, especially sodium polyacrylate resin, thereby making high water absorption amount and high water absorption rate no longer be an obstacle for the use of sodium polyacrylate as a fire-extinguishing agent, but an advantage. The resin powder and water flow do not need to be mixed in any closed or semi-enclosed space, instead they are directly mixed in the air, which can solve the influence of high viscosity after water absorption on the spraying of the fire-extinguishing agents to the greatest extent. The strong water flow or water mist sprayed from the water spray pipe may transport a resin-formed gel to a longer distance, and when the water flow is sprayed rapidly, a certain negative pressure can also be generated inside the water column, which may suck the sprayed resin powder floating with the air flow into the water flow, making good use of the characteristics of the resin powder such as low density and small particles. At the same time, the power spray pressure may also be reduced according to actual requirements.

4. In the present application, a water blocking jacket is provided outside the powder spray port, and most of the splashed water spray are blocked by the water blocking jacket and stuck to an outer wall of the water blocking jacket, so that the powder spray port located on the inner wall is not blocked by gel or paste, and the spray pipe is not contaminated, thus the biggest technical problem is solved with a very simple part. In practice, since the water monitor is mostly operated manually, the spraying direction of the water flow, the amount of the water, and the spraying pressure of water are likely to fluctuate greatly. Therefore, some gelatinous substances that absorb water will inevitably be piled up at the powder spray port. Once these substances accumulate to a certain extent, the area of the powder spray port and the water spray port will be reduced, which will greatly reduce the use efficiency of the firefighting device. In this regard, we designed the front end of the water nozzle as a detachable water blocking jacket. On the one hand, the diameter of the water blocking jacket is much larger than that of the powder spray port, and the water blocking jacket is generally in the shape of a table bell, with a relatively large opening and a relatively large inner space. Once the accumulation is formed, the accumulation may be removed directly by using a screwdriver and other tools. According to the experiment, once the accumulation is formed, they are very closely connected to each other and form a whole, and they can be taken out all at once when they are removed. On the other hand, once the powder jet port is blocked for any reason during use, we can also replace the water blocking jacket immediately to achieve the purpose of quickly re-starting operation. This method can solve the blockage problem as quickly as possible, because according to the experiment, the blockage of the powder spray port accounts for more than 90% of all blockages, and the blockage of the water spray port is generally caused by a chain reaction after the blockage of the powder spray port. Meanwhile, if the powder spray port is blocked, even if the powder nozzle pipeline is blocked, it will not cause the blockage of a long-distance pipeline, because the strong water absorption and sealing ability of sodium polyacrylate will quickly seal the pipeline. Therefore, when the water blocking jacket is removed, the accumulation in the powder nozzle will be taken out as a whole. In addition, when other fire-extinguishing agents are used, the pollution caused by a backflow of the water flow from the powder spray port may also be solved by cleaning the water blocking jacket, which is simple and easy to implement.

5. The present application has changed the previous way of using superabsorbent resins as a fire-extinguishing agent in the firefighting field, from the previous use after pre-mixing to the way that is ready-to-spray and ready-to-use, which greatly improves a fire extinguishing efficiency and does not require an additional stirring device. It is equivalent to not changing the traditional water column fire-extinguishing way, but adding a set of powder-spray devices in the middle of the water monitor, forming a new fire extinguishing way of spraying powder on the sprayed water column. The power is carried away by the water column, while the powder and the water are mixed and absorbed, and the water absorption and mixing are fully completed within a few seconds of reaching a fire site. When the water flow reaches the fire site, the fire-extinguishing gel is also just formed, which does not affect the previous advantages of rapid fire extinguishing response.

6. The overlapping structure of the powder nozzle and the water nozzle is not much different from existing two-phase mixed-spray equipment, and has simple production process, simple construction, small and beautiful appearance, small space occupation, and convenient and fast installation and maintenance or replacement of parts. For manufacturers, in the pursuit of cost balance, there is no need to make a substantial change on existing fire water monitors, water guns or water hoses. To achieve the technical effect of the present application, the original water nozzle and powder nozzle can be used, and only the water spray port is required to be extended outward appropriately by some baffles and pipe-wall structures, which greatly reduces transformation cost.

### BRIEF DESCRIPTION OF THE DRAWINGS

FIG. 1 is a schematic structural diagram of a multiphase jet water monitor in a prior art;

FIG. 2 is a schematic structural diagram of a multiphase jet water gun in the prior art;

FIG. 3 is a schematic structural diagram of a multiphase jet water monitor in the prior art;

FIG. 4 is a schematic structural diagram of a multiphase jet water monitor in the prior art;

FIG. 5 is a schematic structural diagram of an embodiment of a firefighting device of the present application;

FIG. 6 is a schematic diagram of an end face of a spray port location of an embodiment of the firefighting device of the present application the firefighting device;

FIG. 7 is a schematic diagram of a spray port location of an embodiment of the firefighting device of the present application;

FIG. 8 is a schematic diagram of a spray port location of an embodiment of the firefighting device of the present invention;

FIG. 9 is a schematic diagram of a spray port location of an embodiment of the firefighting device of the present invention.

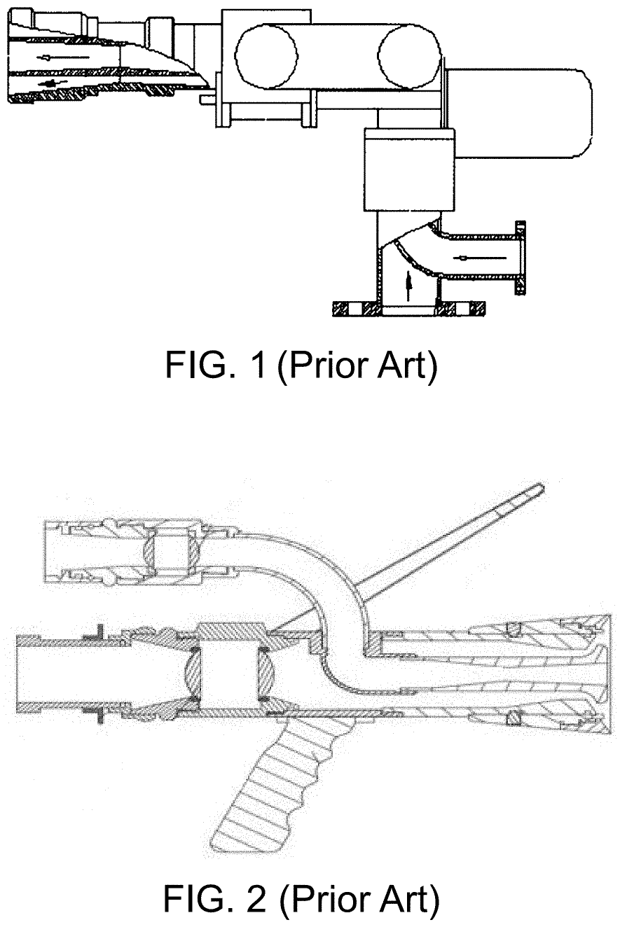

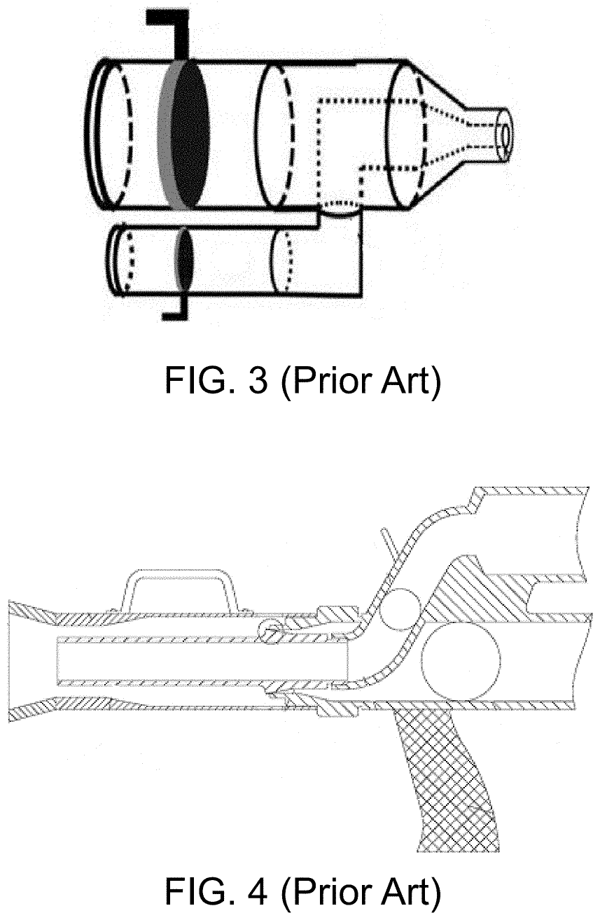

### DESCRIPTION OF THE EMBODIMENTS

Embodiments of the present application are described in detail below. The following embodiments are implemented on the premise of the technical solutions of the present application, and provide detailed implementations and specific operation processes, but the protection scope of the present application is not limited to the following embodiments.

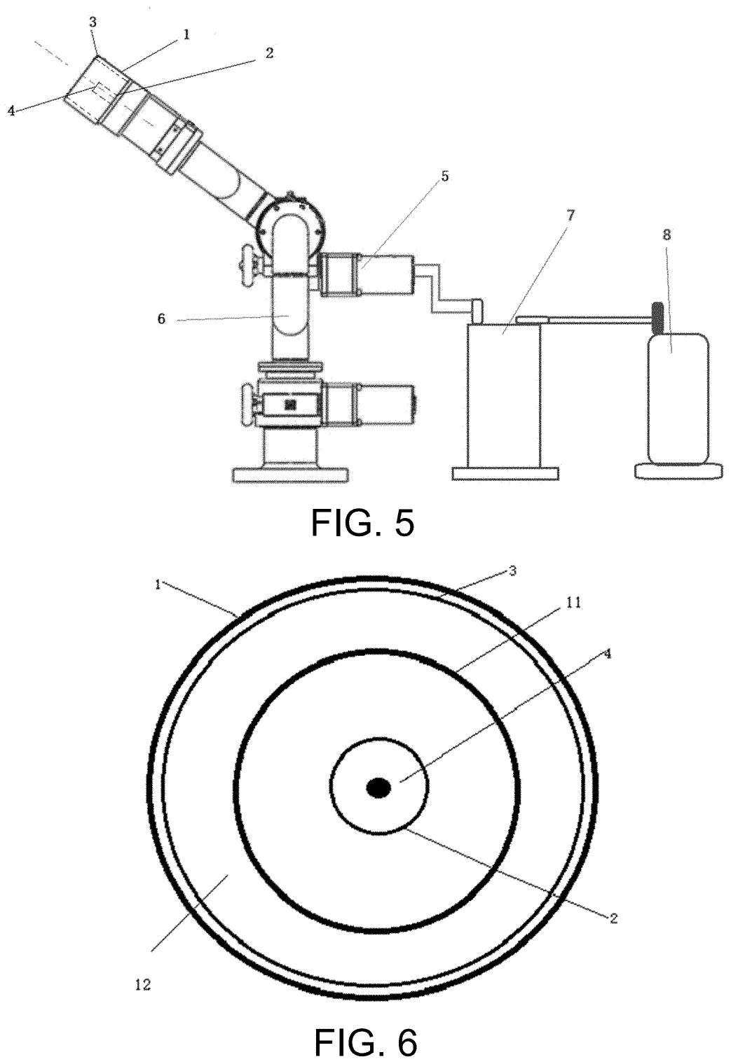

Referring to FIG. 5, the present application relates to a technical field of firefighting equipment, and discloses and provides a mixed-spray firefighting device, including a water nozzle 1 and a powder nozzle 2. The water nozzle 1 is disposed around an outside of the powder nozzle 2, and a powder spray port 4 of the powder nozzle 2 is provided behind a water spray port 3 of the water nozzle 1.

Generally speaking, a firefighting device includes several components, such as a water pump, a high-pressure pump, a pipeline, a valve, a water connection, a control device, etc., but as for the present application, it only includes two core parts, that is, a powder jet device and a water jet device. As long as the powder spray device and the water spray device are disposed in proper positions, the inventive objective of the present application can be achieved. The test of our company in the previous period was mainly performed on the transformation of the mixed-jet equipment in the prior art, because in the prior art, there is a mixed-jet equipment in which powder and high-pressure water column are jetted together to extinguish the fire, which saves a development cost and has a very low test cost. However, after a series of tests, and several varieties of superabsorbent resins were replaced halfway, the spraying effect could not be achieved very well. In the existing three-phase or two-phase mixed-jet firefighting equipment, the water spray port and the powder spray port are nested with each other, and the water spraying and the powder spraying are carried out simultaneously, and the water and the powder are wrapped around each other and ejected out. Due to the high pressure of a high pressure water column, a collision between water lines is relatively intense, and the splashing water is very easy to enter the surrounding of the powder jet port. Compared with the existing powder fire-extinguishing agent, the biggest difference of the superabsorbent resin powder is that it is neither soluble in water nor hydrophobic, but rapidly expands when it encounters water and its viscosity increases rapidly, and becomes gel-like; and gradually develops to a solid gel to seal the surrounding inner wall of the powder spray port, and eventually completely seal the powder spray port, resulting in the resin as a fire-extinguishing agent not being ejected. In some cases, for example, when the high-pressure water flow is just sprayed out or just closed, the water flow often flows directly to the powder spray port, and the gel is formed at the spray port to directly seal the powder spray port.

In response to this problem, we creatively proposed a technical solution to change the position of the powder nozzle from the same plane or substantially the same plane as the water nozzle to a relatively behind position. It should be emphasized that the powder spray port 4 of the powder nozzle 2 and the water spray port 3 of the water nozzle 1 refer to the position where a powder and a liquid are ejected out of a closed pipeline and in contact with the outside air, respectively, and the water spray port 3 may not be a pipe opening for the whole device. In this case, both the water nozzle 1 and the powder nozzle 2 have at least a section of independent pipelines at the front, which can prevent the water flow from being directly sprayed from the outer pipe wall of the powder nozzle 2, thereby causing water splashing near the powder spray port 4. For example, in the firefighting device shown in FIG. 4, although the powder spray port is located behind the pipe opening, it can be clearly seen that a casing pipe is disposed on the head of the water nozzle of the device, so the pipe opening and the water spray port thereof are not coincident with each other; the water spray port is still roughly in the same plane as the powder spray port, and the water flow ejected out of the closed space formed by the pipe wall of the water nozzle and the pipe wall of the powder nozzle can be considered as the water flow being ejected out of the water spray port. According to our experimental conclusions, in the case of entry into an open space from a closed pipeline, the change of pressure will make the high-speed spray water column produce water spray to the greatest extent; meanwhile, the collision water spray generated in the structural change will be more obvious. Under this solution, a configuration in which a water spraying position and a powder spraying position are substantially separated by a certain distance is formed. Although the two spray ports overlap and are relatively close when viewed from an end face, the distance A in the axial direction has been effectively elongated, and the powder spray port 4 has a buffer distance from the water spray port 2 with the most sputtering water spray. Under this design, the fire-extinguishing agent powder, especially sodium polyacrylate resin powder, can still be directly sprayed from the middle to the surrounding high-pressure water column at a high rate under the action of the pressurized gas due to its low density and small particles. Further, due to its excellent water absorption rate, the sodium polyacrylate resin powder can be quickly added to the water flow and fly to the fire site with the water flow. The resin powder will not adhere to the pipe wall in large quantities under the strong negative-pressure traction of high-pressure water column.

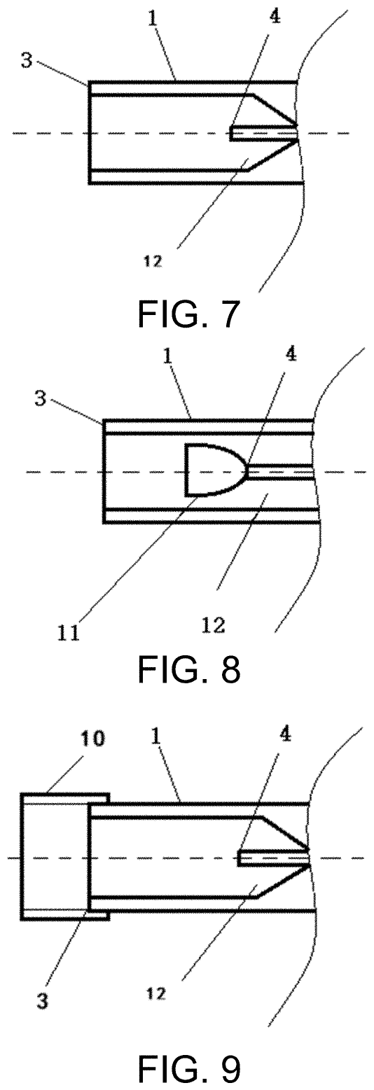

Referring to FIGS. 7-9, a position of the powder spray port 4 is located behind a position of the water spray port 3. The superabsorbent resin powder is sprayed into the water flow from the rear of the water spray port 3 of the water nozzle 1. This design can effectively lengthen a distance between the powder spray port 4 and the water spray port 3, and place the powder spray port that is easy to block in a position where water droplets cannot be splashed, basically eliminating the blockage problem of the powder spray port 4. The reason why this design can be realized is mainly because the powder spray itself has a certain pressure, which can ensure that the powder does not drift away on a large scale in a short distance. Secondly, under the action of the strong negative pressure of the high-pressure water column, the resin powder with a low density can be suction very well. Thirdly, if required, the way of adding a water blocking jacket 11 can be used to relieve the powder from drifting and getting wet. In this way, the advantages of the sodium polyacrylate resin powder can be fully utilized and brought into play and the disadvantages of easily blocking the outlet or backflow can be avoided.

If only from the perspective of mixing the two substances, the mixing effect of the firefighting device of the present application may not be better than that of the existing casing-type mixed-jet system, but the present application solves the new problem caused by the use of new fire-extinguishing agent powder. Superabsorbent resin powder, especially sodium polyacrylate resin powder, has produced a good technical effect when it is used as a fire-extinguishing agent, giving full play to the characteristics of sodium polyacrylate resin powder. Even if the mixing effect is not perfect due to a large divergence surface at the beginning, in the process of the water column reaching the fire site, sodium polyacrylate powder will still absorb a large amount of water molecules in the water column, and will continue to absorb water molecules after attaching to fire objects, until it absorbs more than 300-500 times of water in volume, achieving an excellent fire-extinguishing effect.

The superabsorbent resin powder ejected from the powder nozzle 2 is mixed with the water flow ejected from the water nozzle 1 in the air outside the firefighting device. Theoretically, the direction of the powder ejected from the powder spray port 4 should intersect with the direction of the water ejected from the water spray port 3. Under the design of the present application, although the water nozzle 1 is not inclined inward, because the diameter of a water feeding pipe is smaller than that of the water nozzle 1, there is a process of high-speed diffusion outward during the spraying process. In this way, when the high-pressure water flow is sprayed horizontally, the spraying direction of the high-pressure water flow will be refracted by the pipe wall, and will converge slightly towards the central axis of the water nozzle 1, so that the high-pressure water flow can obliquely intersect with the powder sprayed in a straight line from the middle, which is conducive to further mixing of solid and liquid. This situation is more pronounced where an outer sleeve 10 is provided. The internal structure of the water nozzle 1 has many forms, but the final spraying direction of the water flow is inclined with respect to the powder spraying direction. In fact, the high-pressure water column also converges at a certain distance from the pipe opening, so that the resin powder sprayed from the powder spray port 4 can be sprayed onto the high-pressure water column from the middle, so as to maximize the use of a water curtain generated by the high-pressure water column to intercept drifting powder to the surface of the water column. In some cases, the shape of the water nozzle 1 and the shape of the powder nozzle 2 may not be very regular, but this does not affect the spraying of water flow and powder along the direction we designed, and it can be ensured as far as possible that the shapes of spraying passages formed inside the water nozzle 1 and the powder nozzle 2 are completely symmetrical. The water flow and powder are ejected from the water nozzle 1 and the powder nozzle 2 independently, and then collide and are mixed at a certain distance from the pipe opening, which better solves the problem that the powder spray port 4 is sealed by gel.

The superabsorbent resin powder is preferably sodium polyacrylate resin powder. According to our company's tests, not all superabsorbent resin powders can achieve an optimal fire-extinguishing effect. There are obvious differences between various superabsorbent resin powders on water absorption mixing effect and state transition effect. The superabsorbent resin powder after water absorption is sprayed to the fire site, causing a different fire-extinguishing effect. The water absorption rate, water absorption ratio, viscosity, density and other indicators of the sodium polyacrylate resin powder are very suitable for the firefighting device and mixed method of the present application, and can achieve an excellent fire-extinguishing effect.

In addition, other types of fire-extinguishing agent powders may also be used, such as water-soluble powder fire-extinguishing agent, sodium alginate mentioned in some literatures, soluble calcium salts, etc., however, powder dissolving in water more quickly has a relatively good effect according to test results. In fact, the firefighting device of the present application can theoretically use almost all kinds of powder fire-extinguishing agents. However, in term of the mixing effect alone, the present application may not be superior to the prior art. For example, in the case of spraying hydrophobic dry powder fire-extinguishing agent, a much higher pressure is required when compared with the pressure at which the sodium polyacrylate powder is sprayed, so as to ensure a basic mixing effect. However, actually, the present application is not designed only to solve the problem of mixing effect. What kind of structure can minimize the influence of the water flow on the powder pipeline is a core of the present application. The mixed-jet structure used by many powder fire-extinguishing agents adopts the mode of internal powder and external water, which requires the powder and water to be pre-mixed in a special container or pipeline for fire trucks and then be sprayed. Some powder spray pipes are even directly inserted into the water spray pipes, which easily causes residual water to enter the powder pipeline, thereby causing pollution and blockage. By adopting the design of the present application, although the mode of external water and internal powder is still kept, the relative position of the powder spray port and the water spray port are effectively adjusted, and a mixed position of the water flow and the powder is optimized, which can solve the problem of the residual water flowing back into the pipeline, so that the subsequent cleaning work is relatively simple, the pollution and corrosion are small, and beneficial technical effects are also obtained.

The water nozzle 1 and the powder nozzle 2 are integrally disposed. The water nozzle 1 and the powder nozzle 2 generally refer to parts of the water spray device and the powder spray device close to the water spray port 3 and the powder spray port 4, respectively. Referring to FIGS. 6-9, in the integrated mode, the water nozzle 1 and the powder nozzle 2 are integrated into an independent structure, and only two independent spray pipelines are required to be divided. As shown in FIGS. 7-9, the specific shapes of the water spray pipe 3 and the powder spray pipe 4 may be relatively flexible, the open area may also be adjusted as required, and the shape of the sprayed water column may also be hollow or other suitable shapes. The whole system has a very simple structure, a small volume, and a beautiful appearance. The device cannot be damaged easily during training, transportation and firefighting.

Referring to FIGS. 7-9, the distance between the powder spray port 4 of the powder nozzle 2 and the water spray port 3 of the water nozzle 1 in the axial direction is greater than 3 cm. The powder spray port 4 is provided with a water blocking jacket 11. A drainage space 12 is provided between the water blocking jacket 11 and the pipe wall of the water nozzle 1. A drainage space 12 is provided between the pipe wall of the powder nozzle 2 and the pipe wall of the water nozzle 1. A front portion of the water nozzle 1 is provided with an outer sleeve 10.

Generally, the distance between the powder spray port 4 and the water spray port 3 will not be too long, for example, more than 15 cm. However, due to the low density and small particles of some fire-extinguishing agent powders, the dispersion effect thereof is strong under the action of high-pressure gas. When the distance A is longer, the water blocking jacket 11 may be arranged at the powder spray port 4 to seal part of the area outside the powder spray port 4, which is of great significance to avoid water splashing and backflow. In particular, the drainage space 12 is provided between the water blocking jacket 11 and the pipe wall of the water nozzle 1, or between the pipe wall of the powder nozzle 2 and the pipe wall of the water nozzle 1, which can effectively reduce the possibility of the water flowing into the surrounding of the powder spray port 4. Certainly, the arrangement mentioned here does not only refer to a composition of a specific solid structure, but also refer to a certain design on a water passage, so that the water column is sprayed in a certain shape or form, such as spraying against the outer pipe wall, then the water barrier space 12 is naturally formed between the spray nozzles to keep the spray ports away from each other. In addition, such design also considers the actual working process of the high-pressure water monitor. A use angle of the water monitor is generally obliquely upward. When a valve of the high-pressure water monitor is just opened, there is a process for the valve opening, and there is no residual water in the pipeline. Therefore, the high-pressure water column cannot be formed instantaneously at the beginning, but is gradually formed from a low-pressure water column to a high-pressure water column, and this process generally causes the water flow in the water monitor to flow directly under the water nozzle 1. In addition, when the high-pressure water monitor just finishes spraying, the valve is required to be closed gradually. During the process of closing the valve, the pressure and water volume in the pipeline gradually decrease, until the finally sprayed water column falls down directly due to insufficient pressure, which will cause this part of the water flow to drop directly to the inner side of the pipe wall of the water nozzle 1. If the water flow can flow directly along the pipe wall to the powder spray port 4, the powder spray port 4 will inevitably be blocked. We have designed the drainage space 12 here, and most of the water flow that falls down due to the insufficient pressure can flow into the drainage space 12 along the pipe wall, which basically solves the above problems. Since the actual amount of water flowing into the water nozzle 1 is not very large, and the powder spray port 4 may be blocked only due to the formation of the absorbent gel, the pipe opening will not be blocked, as long as the water is properly discharged or temporarily stored. Here, it is possible to flexibly choose the discharge mode for the water flow entering the water nozzle 1, for example, providing a drainage hole directly under the water nozzle 1.

The water nozzle 1 belongs to a part of the fire water monitor, fire hose or fire water gun and is connected to the water spray pipe 5, and can spray the high-pressure water flow or water mist. Referring to FIG. 5, it can be seen that the firefighting device of the present application can actually be obtained by transformation from most of existing mixed-spray firefighting devices. Regardless of the original water monitor or water gun, as long as the positional nesting relationship between the powder spray pipe and the powder nozzle is modified to a certain extent, the firefighting device of the present application may be obtained. This is also a major contribution of the present application. Instead of simply abandoning a large number of existing firefighting devices, according to the characteristics of the powder fire-extinguishing agent, the best pipeline configuration is selected in the existing firefighting devices. The powder spray port has been changed from being disposed roughly on the same plane as the water spray port to being disposed at a certain distance behind the water spray port, so that when the sodium polyacrylate resin powder is used as a fire-extinguishing agent, its maximum efficiency is exerted, and the cost of the whole system is minimized.

Referring to FIG. 5, the powder nozzle 2 is connected with a powder spray pipe 6, and the powder spray pipe 6 is connected with the powder storage tank 7, and the powder storage tank 7 is connected with the high-pressure gas source 8. This is also a configuration of the conventional powder spray device of the mixed-jet equipment. Certainly, the powder nozzle is directly connected to other types of powder supplying devices, which does not affect the effect of the present application. The core is that the fire-extinguishing agent sprayed by the powder spray device can be sprayed to the water column, and the water spray splashed at the water spray port 3 does not enter the powder spray port 4.

In addition, the present application further provides a mixed-spray method for a powder fire-extinguishing agent and water. The superabsorbent resin fire-extinguishing agent powder sprayed from the powder spray port 4 of the powder nozzle 2 are sprayed from the powder nozzle 2 in the middle, and is mixed with the water flow sprayed from the water spray port 3 surrounding the powder nozzle 2 in the air outside the water nozzle 1. The fire-extinguishing agent powder is sodium polyacrylate resin powder. The fire-extinguishing agent powder is sprayed from the rear of the position of the water spray port 3.

The application is beneficial in that: it solves the technical bottleneck of using sodium polyacrylate resin powder and the like as a fire-extinguishing agent in the prior art, so that the powder fire-extinguishing agent such as sodium polyacrylate resin powder can be smoothly and continuously sprayed into a fire field, without blocking the powder spray port or causing a pipeline pollution.

The above descriptions are only preferred embodiments of the present application and are not intended to limit the present application. Any modifications, equivalent replacements and improvements made within the spirit and principles of the present application shall be included in the protection scope of the present application.

1. A mixed-spray firefighting device, comprising a water nozzle and a powder nozzle, wherein the water nozzle is disposed around an outside of the powder nozzle, and a powder spray port of the powder nozzle is disposed behind a water spray port of the water nozzle.

2. The mixed-spray firefighting device according to claim 1, wherein a fire-extinguishing agent powder sprayed from the powder nozzle and a water flow sprayed from the water nozzle are mixed in air outside the firefighting device.

3. The mixed-spray firefighting device according to claim 2, wherein the fire-extinguishing agent powder is sodium polyacrylate resin powder.

4. The mixed-spray firefighting device according to claim 1, wherein the powder spray port of the powder nozzle and the water spray port of the water nozzle refer to a position where a powder and a liquid are ejected from a closed pipeline and in contact with outside air, respectively.

5. The mixed-spray firefighting device according to claim 1, wherein a distance between the powder spray port of the powder nozzle and the water spray port of the water nozzle in an axial direction is greater than 3 cm.

6. The mixed-spray firefighting device according to claim 1, wherein the powder nozzle further comprises a detachable water blocking jacket provided at a front of the powder nozzle.

7. The mixed-spray firefighting device according to claim 1, wherein a drainage space is provided between a pipe wall of the powder nozzle and a pipe wall of the water nozzle.

8. The mixed-spray firefighting device according to claim 1, wherein an outer sleeve is provided at a front of the water nozzle.

9. The mixed-spray firefighting device according to claim 1, wherein the water nozzle is connected with a water spray pipe and is capable of spraying high-pressure water flow or water mist, the powder nozzle is connected with a powder spray pipe, the powder spray pipe is connected with a powder storage tank, and the powder storage tank is connected with a high-pressure gas source.

10. A mixed-spray method of powder fire-extinguishing agent and water, wherein a superabsorbent resin fire-extinguishing agent powder sprayed from a powder spray port of a powder nozzle is sprayed from the powder nozzle and is mixed with a water flow sprayed from a water spray port surrounding the powder nozzle in air outside a water nozzle, and the water nozzle is disposed around an outside of the powder nozzle.

11. The mixed-spray method according to claim 10, wherein the fire-extinguishing agent powder is sodium polyacrylate resin powder.

12. The mixed-spray method according to claim 11, wherein the fire-extinguishing agent powder is sprayed from a rear of a position of the water spray port.
